(19) United States
(12) Patent Application Publication
(10) Pub. No.: US 2013/0231417 A1
(43) Pub. Date: Sep. 5, 2013

(54) RUBBER COMPOSITION THAT CAN BE USED FOR MANUFACTURING A TYRE OF WHICH THE COMPOSITION COMPRISES A STARCH AND AN AQUEOUS OR WATER-SOLUBLE PLASTICIZER

(71) Applicants: Didier Vasseur, Clermont-Ferrand (FR); Christine Nourry, Clermont - Ferrand (FR); Kyoko Kobayashi, Clermont - Ferrand (FR)

(72) Inventors: Didier Vasseur, Clermont-Ferrand (FR); Christine Nourry, Clermont - Ferrand (FR); Kyoko Kobayashi, Clermont - Ferrand (FR)

(73) Assignees: MICHELIN RECHERCHE ET TECHNIQUE S.A., Granges-Paccot (CH); COMPAGNIE GENERALE DES ETABLISSEMENTS MICHELIN, Clermont-Ferrand (FR)

(21) Appl. No.: 13/641,564

(22) PCT Filed: May 2, 2011
(86) PCT No.: PCT/EP11/56942

§ 371 Date: May 6, 2013

(30) Foreign Application Priority Data
May 4, 2010 (FR) 1053437

(51) Int. Cl. C08L 9/06; C08K 13/02

(52) U.S. Cl. CPC C08L 9/06; C08K 13/02
USPC 523/156

(57) ABSTRACT

A rubber composition based on a diene elastomer, a crosslinking system, and a reinforcing filler is provided, as well as a process for obtaining the composition. The composition includes a starch in a proportion of from 10 to 50 phr (parts by weight per hundred parts of elastomer) and an aqueous or water-soluble plasticizer in a proportion of from 3 to 30 phr. The aqueous or water-soluble plasticizer is water or a mixture of water and glycerol, in which the water is predominant by weight in the aqueous or water-soluble plasticizer. The composition can be used for preparing calendered or profiled tyre-related products, such as a tyre tread, for example.

The invention relates to rubber compositions that can be used as a tyre tread and more particularly to rubber compositions incorporating a starch.

Today, manufacturers try as much as possible to use biodegradable products of vegetable origin in the manufacture of rubber compositions, for replacing certain industrial products.

Thus, European patent application EP0795581 describes rubber compositions for a tyre, comprising, as partial replacement of carbon black, a starch plasticized with a polymer of vinyl alcohol and of ethylene. These compositions are described as allowing a decrease in the rolling resistance compared with starch-free compositions and an adjustment in the stiffness. Moreover, other European patent applications, EP1074582, EP1293530, EP1312639 and EP1514900, also describe rubber compositions comprising a starch plasticized with a polymer of vinyl alcohol and of ethylene, in addition to the usual fillers such as carbon black and/or silica.

Unfortunately, the use of such plasticizers in the compositions risks being detrimental to the wear resistance of the tyre owing to the addition of a supplementary component, and therefore owing to the dilution of the resulting elastomers, which makes these solutions not very optimal.

The use of starch in a tyre therefore requires an alternative solution to those mentioned above, which makes it possible to improve the compromise between rolling resistance and cornering thrust, i.e., which makes it possible to keep a low rolling resistance while at the same time increasing the cornering thrust, or else to decrease the rolling resistance while at the same time retaining the cornering thrust (stiffness), or even increasing it.

The applicant has discovered, surprisingly, that the introduction, into the constituent rubber compositions, for example, of pneumatic tyres, of a starch and of an aqueous or water-soluble plasticizer solves the problems thus far encountered.

Moreover, this solution has many other advantages over the prior art compositions, and in particular:
the use of an effective plasticizer allowing excellent dispersion of the starch;
the use of a plasticizer which totally or partially evaporates in the pneumatic tyre manufacturing process and in particular during curing, thus not being detrimental to the wear resistance of the final product;
the use of a less expensive and less polluting plasticizer.

The invention therefore relates to a rubber composition based on at least one diene elastomer, a crosslinking system and a reinforcing filler, characterized in that the composition also comprises a starch in a proportion of from 10 to 50 phr (parts by weight per hundred parts of elastomer) and an aqueous or water-soluble plasticizer in a proportion of from 3 to 30 phr, said aqueous or water-soluble plasticizer being water, or a mixture of water and glycerol in which the water is predominant by weight in the aqueous or water-soluble plasticizer.

Preferentially, the invention relates to a composition as defined above, in which the proportion of starch ranges from 15 to 40 phr.

Also preferentially, the invention relates to a composition as defined above, in which the proportion of aqueous or water-soluble plasticizer ranges from 7 to 28 phr.

Preferentially, the invention also relates to a composition as defined above, in which the starch consists of a minimum of 10% of amylose, more preferentially of a minimum of 15% of amylose, and even more preferentially of a minimum of 20% of amylose.

Also preferentially, the invention relates to a composition as defined above, in which the aqueous or water-soluble plasticizer is water.

Preferentially, the invention also relates to a composition as defined above, in which the reinforcing filler comprises predominantly carbon black.

In an alternative preferential manner, the invention also relates to a composition as defined above, in which the reinforcing filler comprises predominantly silica.

Equally preferentially, the invention also relates to a composition as defined above, in which the reinforcing filler comprises a blend of carbon black and silica.

In an equivalent manner, the invention relates preferentially to a composition as defined above, in which the composition is in the noncrosslinked state or in the crosslinked state.

The subject matter of the invention is also a tyre comprising the rubber composition as described above.

The subject of the invention is, moreover, the calendered or profiled products comprising a rubber composition in accordance with the invention; preferentially, these products will be selected from the sidewall, the carcass ply, the crown ply, the tread, the bead-wire filling, the sublayer or other layers of elastomers; and very preferentially, this product is the tread.

The subject of the invention is also a tyre comprising a product as described above.

Preferentially, the tyre according to the invention will be selected from tyres intended for fitting onto a two-wheeled vehicle, a passenger vehicle, or else a “heavy-duty” vehicle (i.e., underground trains, buses, off-road vehicles, heavy road transport vehicles such as lorries, tractors, trailers), or else aircraft, and civil engineering, agricultural or handling vehicles.

For the purposes of the present application, the tyre tread denotes the whole tread or a part thereof (including the sublayer), in particular when it is composed of several layers, in contact with the ground.

I—Constituents of the Composition

The rubber compositions according to the invention are based on the following constituents: at least one diene elastomer, a crosslinking system, a reinforcing filler, a starch and an aqueous or water-soluble plasticizer.

The expression “composition based on” should be understood to mean a composition comprising the mixture and/or the product of reaction in situ of the various basic constituents used, some of these constituents being able to react and/or being intended to react with one another, at least partially, during the various phases of manufacture of the composition, or during the subsequent curing, modifying the composition such as it is prepared at the start. Thus, the compositions as employed for the invention may be different in the noncrosslinked state and in the crosslinked state.

In the present description, unless otherwise expressly indicated, all the percentages (%) indicated are percentages by weight. Furthermore, any range of values denoted by the expression “between a and b” represents the range of values of from more than a to less than b (i.e., limits a and b excluded), whereas any range of values denoted by the expression “from a to b” means the range of values going from a up to b (i.e., including the strict limits a and b).

I-1 Diene Elastomer

It is recalled here that “diene” type elastomer (or “rubber”, the two terms being considered to be synonymous) should be understood to mean, in a known manner, an (one or more is intended) elastomer resulting at least in part (i.e., a homopolymer or a copolymer) from diene monomers (monomers carrying two carbon-carbon double bonds which may or may not be conjugated).

Diene elastomers can be classified into two categories: “essentially unsaturated” or “essentially saturated”. The term “essentially unsaturated” is generally intended to mean a diene elastomer derived at least in part from conjugated diene monomers, having a content of units of diene origin (conjugated dienes) which is greater than 15% (mol %); thus, diene elastomers such as butyl rubbers or copolymers of dienes and of alpha-olefins of EPDM type do not come within the previous definition and can in particular be described as “essentially saturated” diene elastomers (low or very low content of units of diene origin, always less than 15%). In the category of “essentially unsaturated” diene elastomers, “highly unsaturated” diene elastomer is understood to mean in particular a diene elastomer having a content of units of diene origin (conjugated dienes) which is greater than 50%.

Given these definitions, the term diene elastomer capable of being used in the compositions according to the invention is understood more particularly to mean:

(a)—any homopolymer obtained by polymerization of a conjugated diene monomer having from 4 to 12 carbon atoms;

(b)—any copolymer obtained by copolymerization of one or more conjugated dienes with one another or with one or more vinylaromatic compounds having from 8 to 20 carbon atoms;

(c)—a ternary copolymer obtained by copolymerization of ethylene and of an α-olefin having from 3 to 6 carbon atoms with a nonconjugated diene monomer having from 6 to 12 carbon atoms, such as, for example, the elastomers obtained from ethylene and from propylene with a nonconjugated diene monomer of the abovementioned type, such as, in particular, 1,4-hexadiene, ethylidenenorbornene, or dicyclopentadiene;

(d)—a copolymer of isobutene and of isoprene (butyl rubber) and also the halogenated versions, in particular chlorinated or brominated versions, of this type of copolymer.

Although it applies to any type of diene elastomer, those skilled in the art of tyres will understand that the present invention is preferably employed with essentially unsaturated diene elastomers, in particular of the type (a) or (b) above.

The following are in particular suitable as conjugated dienes: 1,3-butadiene, 2-methyl-1,3-butadiene, 2,3-di(C₁-C₅ alkyl)-1,3-butadienes, such as, for example, 2,3-dimethyl-1,3-butadiene, 2,3-diethyl-1,3-butadiene, 2-methyl-3-ethyl-1,3-butadiene or 2-methyl-3-isopropyl-1,3-butadiene, aryl-1,3-butadiene, 1,3-pentadiene or 2,4-hexadiene. The following, for example, are suitable as vinylaromatic compounds: styrene, ortho-, meta- or para-methylstyrene, the “vinyltoluene” commercial mixture, para-(tert-butyl)styrene, methoxystyrenes, chlorostyrenes, vinylmesitylene, divinylbenzene or vinylnaphthalene.

The copolymers can contain between 99% and 20% by weight of diene units and between 1% and 80% by weight of vinylaromatic units. The elastomers can have any microstructure which depends on the polymerization conditions used, in particular the presence or absence of a modifying and/or randomizing agent, and on the amounts of modifying and/or randomizing agent employed. The elastomers can, for example, be block, random, sequenced or microsequenced elastomers, and can be prepared in dispersion or in solution; they can be coupled and/or star-branched or else functionalized with a coupling and/or star-branching or functionalization agent. For coupling with carbon black, mention may, for example, be made of functional groups comprising a C—Sn bond or aminated functional groups such as aminobenzophenone, for example; for coupling with a reinforcing inorganic filler, such as silica, mention may be made, for example, of silanol functional groups or polysiloxane functional groups having a silanol end (as described, for example, in FR 2 740 778, U.S. Pat. No. 6,013,718 and WO 2008/141702), alkoxysilane groups (as described, for example, in FR 2 765 882 or U.S. Pat. No. 5,977,238), carboxyl groups (as described, for example, in WO 01/92402 or U.S. Pat. No. 6,815,473, WO 2004/096865 or US 2006/0089445) or else polyether groups (as described, for example, in EP 1 127 909, U.S. Pat. No. 6,503,973, WO 2009/000750 and WO 2009/000752). As other examples of functionalized elastomers, mention may also be made of elastomers (such as SBR, BR, NR or IR) of the epoxidized type.

The following are suitable: polybutadienes and in particular those having a content (molar %) of 1,2-units of between 4% and 80% or those having a content (molar %) of cis-1,4-units of greater than 80%, polyisoprenes, butadiene/styrene copolymers and in particular those having a Tg (glass transition temperature Tg, measured according to ASTM D3418) of between 0° C. and -70° C. and more particularly between −10° C. and −60° C., a styrene content of between 5% and 60% by weight and more particularly between 20% and 50%, a content (molar %) of 1,2-bonds of the butadiene part of between 4% and 75%, a content (molar %) of trans-1,4-bonds of between 10% and 80%, butadiene/isoprene copolymers and in particular those having an isoprene content of between 5% and 90% by weight and a Tg of −40° C. to −80° C., isoprene/styrene copolymers and in particular those having a styrene content of between 5% and 50% by weight and a Tg of between −5° C. and −60° C. In the case of butadiene/styrene/isoprene copolymers, those having a styrene content of between 5% and 50% by weight and more particularly between 10% and 40%, an isoprene content of between 15% and 60% by weight and more particularly between 20% and 50%, a butadiene content of between 5% and 50% by weight and more particularly between 20% and 40%, a content (molar %) of 1,2-units of the butadiene part of between 4% and 85%, a content (molar %) of trans-1,4-units of the butadiene part of between 6% and 80%, a content (molar %) of 1,2- plus 3,4-units of the isoprene part of between 5% and 70% and a content (molar %) of trans-1,4-units of the isoprene part of between 10% and 50%, and more generally any butadiene/styrene/isoprene copolymer having a Tg of between −20° C. and −70° C., are suitable in particular.

In summary, the diene elastomer of the composition is preferentially selected from the group of highly unsaturated diene elastomers consisting of polybutadienes (abbreviated to “BR”), synthetic polyisoprenes (IR), natural rubber (NR), butadiene copolymers, isoprene copolymers and mixtures of these elastomers. Such copolymers are more preferentially selected from the group consisting of butadiene/styrene copolymers (SBR), isoprene/butadiene copolymers (BIR), isoprene/styrene copolymers (SIR), isoprene/butadiene/styrene copolymers (SBIR), butadiene/acrylonitrile copolymers (NBR), butadiene/styrene/acrylonitrile copolymers (NSBR) or a mixture of two or more of these compounds.

According to one particular embodiment, the composition comprises from 50 to 100 phr of an SBR elastomer, whether it is an SBR prepared in emulsion (“ESBR”) or an SBR prepared in solution (“SSBR”).

According to another particular embodiment, the diene elastomer is an SBR/BR blend (mixture).

According to other possible embodiments, the diene elastomer is an SBR/NR (or SBR/IR), BR/NR (or BR/IR) or else SBR/BR/NR (or SBR/BR/IR) blend.

In the case of an SBR (ESBR or SSBR) elastomer, use is made in particular of an SBR having a moderate styrene content, for example of between 20% and 35% by weight, or a high styrene content, for example from 35 to 45%, a content of vinyl bonds of the butadiene part of between 15% and 70%, a content (molar %) of trans-1,4-bonds of between 15% and 75% and a Tg of between −10° C. and −55° C.; such an SBR can advantageously be used as a mixture with a BR preferably having more than 90% (molar %) of cis-1,4-bonds.

According to another particular embodiment, the diene elastomer is a predominantly isoprene elastomer (i.e., in which the weight fraction of isoprene elastomer is the greatest, compared with the weight fraction of the other elastomers). The term “isoprene elastomer” is understood to mean, in a known manner, an isoprene homopolymer or copolymer, in other words a diene elastomer selected from the group consisting of natural rubber (NR) which may be plasticized or peptized, synthetic polyisoprenes (IR), the various copolymers of isoprene and mixtures of these elastomers. Among the isoprene copolymers, mention will in particular be made of isobutene/isoprene copolymers (butyl rubber—IIR), isoprene/styrene copolymers (SIR), isoprene/butadiene copolymers (BIR) or isoprene/butadiene/styrene copolymers (SBIR). This isoprene elastomer is preferably natural rubber or a synthetic cis-1,4-polyisoprene; use is preferably made, among these synthetic polyisoprenes, of polyisoprenes having a level (molar %) of cis-1,4-bonds of greater than 90%, even more preferentially greater than 98%.

According to another preferential embodiment of the invention, the rubber composition comprises a blend of a (one or more) “high Tg” diene elastomer having a Tg of between −70° C. and 0° C. and of a (one or more) “low Tg” diene elastomer having a Tg of between −110° C. and −80° C., more preferentially between −105° C. and −90° C. The high Tg elastomer is preferably selected from the group consisting of S-SBRs, E-SBRs, natural rubber, synthetic polyisoprenes (having a level (molar %) of cis-1,4-structures preferably of greater than 95%), BIRs, SIRs, SBIRs and mixtures of these elastomers. The low Tg elastomer preferably comprises butadiene units according to a level (molar %) at least equal to 70%; it preferably consists of a polybutadiene (BR) having a level (molar %) of cis-1,4-structures of greater than 90%.

According to another particular embodiment of the invention, the rubber composition comprises, for example, between 30 and 90 phr, in particular between 40 and 90 phr, of a high Tg elastomer as a blend with a low Tg elastomer.

According to another particular embodiment of the invention, the diene elastomer of the composition according to the invention comprises a blend of a BR (as low Tg elastomer) having a level (molar %) of cis-1,4-structures of greater than 90%, with one or more S-SBRs or E-SBRs (as high Tg elastomer(s)).

The compositions can contain a single diene elastomer or a mixture of several diene elastomers.

I-2 Reinforcing Filler

Use may be made of any type of reinforcing filler known for its abilities to reinforce a rubber composition that can be used in the manufacture of tyres, for example an organic filler, such as carbon black, a reinforcing inorganic filler, such as silica, or else a blend of these two types of filler, in particular a blend of carbon black and silica.

All carbon blacks, in particular “tyre-grade” blacks, are suitable as carbon blacks. Among the latter, mention will more particularly be made of the reinforcing carbon blacks of the 100, 200 or 300 series (ASTM grades), for instance the N115, N134, N234, N326, N330, N339, N347 or N375 blacks, or else, according to the intended applications, the blacks of higher series (for example, N660, N683 or N772). The carbon blacks could, for example, be already incorporated into an isoprene elastomer in the form of a masterbatch (see, for example, applications WO 97/36724 or WO 99/16600).

As examples of organic fillers other than carbon blacks, mention may be made of the functionalized polyvinyl organic fillers as described in applications WO-A-2006/069792, WO-A-2006/069793, WO-A-2008/003434 and WO-A-2008/003435.

The term “reinforcing inorganic filler” should be understood, in the present application, by definition, as meaning any inorganic or mineral filler (regardless of its colour and its natural or synthetic origin), also known as “white” filler, “clear” filler or even “non-black filler”, in contrast to carbon black, capable of reinforcing by itself, without means other than an intermediate coupling agent, a rubber composition intended for the manufacture of tyres, in other words capable of replacing, in its reinforcing role, a conventional tyre-grade carbon black; such a filler is generally characterized, in a known manner, by the presence of hydroxyl (—OH) groups at its surface.

The physical state in which the reinforcing inorganic filler is provided is not important, whether it is in the form of a powder, of microbeads, of granules, of beads or any other appropriate densified form. Of course, the term “reinforcing inorganic filler” is also understood to mean mixtures of various reinforcing inorganic fillers, in particular of highly dispersible siliceous and/or aluminous fillers as described hereinafter.

Mineral fillers of the siliceous type, in particular silica (SiO₂), or of the aluminous type, in particular alumina (Al₂O₃), are suitable in particular as reinforcing inorganic fillers. The silica used can be any reinforcing silica known to those skilled in the art, in particular any precipitated or fumed silica having a BET surface area and a CTAB specific surface area both of less than 450 m²/g, preferably from 30 to 400 m²/g. As highly dispersible (termed “HDS”) precipitated silicas mention will, for example, be made of the Ultrasil 7000 and Ultrasil 7005 silicas from the company Degussa, the Zeosil 1165MP, 1135MP and 1115MP silicas from the company Rhodia, the Hi-Sil EZ150G silica from the company PPG, the “Zeopol” 8715, 8745 and 8755 silicas from the company Huber, treated precipitated silicas, such as, for example, the aluminium-“doped” silicas described in application EP-A-0735088 or the silicas with a high specific surface area as described in application WO 03/16837.

The reinforcing inorganic filler used, in particular when it is silica, preferably has a BET surface area of between 45 and 400 m²/g, more preferentially between 60 and 300 m²/g.

The volume fraction of reinforcing filler in the rubber composition is defined as being the ratio of the volume of the reinforcing filler to the volume of all the constituents of the composition, it being understood that the volume of all the constituents is calculated by adding together the volume of each of the constituents of the composition. The volume fraction of reinforcing filler in a composition is therefore defined as the ratio of the volume of the reinforcing filler to the sum of the volumes of each of the constituents of the composition; typically, this volume fraction is between 10% and 30%, preferentially between 15% and 25%.

In an equivalent preferential manner, the level of total reinforcing filler (carbon black and/or reinforcing inorganic filler such as silica) is between 40 and 200 phr, more preferentially between 50 and 120 phr.

According to one preferential embodiment of the invention, use is made of a reinforcing filler comprising between 40 and 150 phr, more preferentially between 55 and 120 phr of reinforcing filler, particularly of silica, and optionally of carbon black; the carbon black, when it is present, is used in combination with silica, more preferentially at a level of less than 20 phr, even more preferentially less than 10 phr (for example between 0.1 and 10 phr).

These compositions can optionally also contain, in addition to the coupling agents, coupling activators, agents for coating the inorganic fillers or more generally processing aids capable, in a known manner, by virtue of an improvement in the dispersion of the filler in the rubber matrix or of a decrease in the viscosity of the compositions, of improving their processing ability in the raw state, these agents being, for example, hydrolysable silanes such as alkylalkoxysilanes, polyols, polyethers, primary, secondary or tertiary amines, or hydroxylated or hydrolysable polyorganosiloxanes.

Use is made in particular of silane polysulphides, referred to as “symmetrical” or “unsymmetrical” depending on their specific structure, as described, for example, in applications WO 03/002648 (or US 2005/016651) and WO 03/002649 (or US 2005/016650).

“Symmetrical” silane polysulphides corresponding to the following general formula (I):

Z-A-Sₓ-A-Z , in which: (I)
x is an integer from 2 to 8 (preferably from 2 to 5);
A is a divalent hydrocarbon-based radical (preferably, C₁-C₁₈ alkylene groups or C₆-C₁₂ arylene groups, more particularly C₁-C₁₀, in particular C₁-C₄, alkylenes, especially propylene);
Z corresponds to one of the formulae hereinafter:

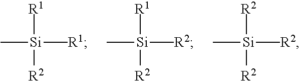

in which:
the R¹ radicals, which are substituted or unsubstituted and identical to or different from one another, represent a C₁-C₁₈ alkyl, C₅-C₁₈ cycloalkyl or C₆-C₁₈ aryl group (preferably, C₁-C₆ alkyl, cyclohexyl or phenyl groups, in particular C₁-C₄ alkyl groups, more particularly methyl and/or ethyl),
the R² radicals, which are substituted or unsubstituted and identical to or different from one another, represent a C₁-C₁₈ alkoxyl or C₅-C₁₈ cycloalkoxyl group (preferably, a group selected from C₁-C₈ alkoxyls and C₅-C₈ cycloalkoxyls, even more preferentially a group selected from C₁-C₄ alkoxyls, in particular methoxyl and ethoxyl), are suitable in particular, without the above definition being limiting.

In the case of a mixture of alkoxysilane polysulphides corresponding to the above formula (I), in particular the usual commercially available mixtures, the mean value of the “x” is a fractional number preferably of between 2 and 5, more preferentially close to 4. However, the invention can also be advantageously carried out, for example, with alkoxysilane disulphides (x=2).

By way of examples of silane polysulphides, mention will more particularly be made of bis((C₁-C₄)alkoxyl(C₁-C₄)alkylsilyl(C₁-C₄)alkyl) polysulphides (in particular disulphides, trisulphides or tetrasulphides), for instance bis(3-trimethoxysilylpropyl) or bis(3-triethoxysilylpropyl) polysulphides. Among these compounds, use is in particular made of bis(3-triethoxysilylpropyl) tetrasulphide, abbreviated to TESPT, of formula [(C₂H_{S}O)₃Si(CH₂)₃S₂]₂, or bis(triethoxysilylpropyl) disulphide, abbreviated to TESPD, of formula [(C₂H_{S}O)₃Si(CH₂)₃Sh. Mention will also be made, by way of preferential examples, of bis(mono(C₁-C₄)alkoxyldi(C₁-C₄)alkylsilylpropyl) polysulphides (in particular disulphides, trisulphides or tetrasulphides), more particularly bis(monoethoxydimethylsilylpropyl) tetrasulphide, as described in patent application WO 02/083782 (or US 2004/132880).

By way of coupling agent other than alkoxysilane polysulphide, mention will also be made of bifunctional POSs (polyorganosiloxanes) or else hydroxysilane polysulphides (R²═OH in formula VIII above) as described in patent applications WO 02/30939 (or U.S. Pat. No. 6,774,255) and WO 02/31041 (or US 2004/051210), or else silanes or POSs carrying azodicarbonyl functional groups, as described, for example, in patent applications WO 2006/125532, WO 2006/125533 and WO 2006/125534.

In the rubber compositions in accordance with the invention, the content of coupling agent is preferentially between 4 and 12 phr, more preferentially between 5 and 10 phr.

Those skilled in the art will understand that a reinforcing agent of another nature, in particular organic nature, could be used as filler equivalent to the reinforcing inorganic filler described in the present section, provided that this reinforcing filler is covered with an inorganic layer, such as silica, or else comprises, at its surface, functional sites, in particular hydroxyls, requiring the use of a coupling agent in order to form the connection between the filler and the elastomer.

I-3 Starch

In a known manner, the term “starch” denotes a polysaccharide comprising amylose and amylopectin units. This starch can also be chemically modified, by esterification, hydroxyethylation, acetylation or oxidation or else modified with an acid. For carrying out the invention, use is preferentially made of starches containing a minimum of 10% of amylose, preferentially more than 15% and very preferentially more than 20%. In other words, starches comprising a maximum of 90% of amylopectin, preferentially less than 85% and very preferentially less than 80%, are preferred.

For carrying out the invention, the starch content is between 10 and 50 phr, and preferentially between 15 and 40 phr.

For the purpose of the present invention, the term “aqueous or water-soluble plasticizer” preferentially denotes water, or a mixture of water and glycerol in which the water is predominant by weight in the aqueous or water-soluble plasticizer. Preferentially, the mixtures contain from 0 to 50% of glycerol in water. Water alone is used even more preferentially.

For carrying out the invention, the content of aqueous or water-soluble plasticizer is between 3 and 30 phr, preferentially between 7 and 28 phr.

I-4 Crosslinking System

The crosslinking system may be a vulcanization system; it is preferentially based on sulphur and on a primary vulcanization accelerator. Optionally added to this vulcanization system are various known secondary vulcanization accelerators or vulcanization activators (preferentially 0.5 to 5.0 phr of each), such as zinc oxide, stearic acid, guanidine derivatives (in particular diphenylguanidine), etc. The sulphur is used at a preferential content of between 0.5 and 10 phr, more preferentially between 0.5 and 5.0 phr, for example between 0.5 and 3.0 phr when the invention is applied to a tyre tread.

Use may be made, as (primary or secondary) accelerator, of any compound capable of acting as an accelerator of vulcanization of diene elastomers in the presence of sulphur, in particular accelerators of the thiazole type and also derivatives thereof, and accelerators of zinc dithiocarbamate or thiuram type. These accelerators are more preferentially selected from the group consisting of 2-mercaptobenzothiazyl disulphide (abbreviated to “MBTS”), N-cyclohexyl-2-benzothiazyl sulphenamide (abbreviated to “CBS”), N, N-dicyclohexyl-2-benzothiazyl sulphenamide (abbreviated to “DCBS”), N-tert-butyl-2-benzothiazyl sulphenamide (abbreviated to “TBBS”), N-tert-butyl-2-benzothiazyl sulphenamide (abbreviated to “TBSI”), zinc dibenzyldithiocarbamate (abbreviated to “ZBEC”) and mixtures of these compounds. A primary accelerator of the sulphenamide type is preferably used.

I-5 Other Possible Additives

The rubber compositions in accordance with the invention optionally also comprise all or a portion of the usual additives customarily used in elastomer compositions intended in particular for the manufacture of treads, for instance pigments, protection agents, such as antiozone waxes, chemical antiozones, antioxidants, plasticizing agents other than those mentioned above, antifatigue agents, reinforcing resins, methylene acceptors (for example, novolac phenolic resin) or methylene donors (for example, HMT or H3M), a crosslinking system based either on sulphur, or on donors of sulphur and/or peroxide and/or bismaleimides, vulcanization accelerators and vulcanization activators.

According to one preferential embodiment, the composition according to the invention also comprises an additional plasticizing agent which is nonaqueous and water-insoluble. Preferably, this plasticizing agent is a solid hydrocarbon-based resin, a nonaqueous and water-insoluble liquid plasticizer, or a mixture of the two.

When it is included in the composition, the total content of nonaqueous and water-insoluble plasticizing agent is preferentially greater than 5 phr, more preferentially between 10 and 100 phr, in particular between 12 and 80 phr, for example between 15 and 50 phr.

According to a first preferential embodiment of the invention, the nonaqueous and water-insoluble plasticizer is a plasticizer which is liquid at 20° C., termed “low Tg” plasticizer, i.e., a plasticizer which, by definition, has a Tg below −20° C., preferably below −40° C.

Any extending oil, whether it is aromatic or nonaromatic in nature, or any liquid nonaqueous and water-insoluble plasticizing agent known for its plasticizing properties with respect to diene elastomers, can be used. At ambient temperature (20° C.), these nonaqueous and water-insoluble plasticizers or these oils, which are more or less viscous, are liquid (i.e., to summarize, substances having the ability to ultimately take the shape of their container), as opposed in particular to hydrocarbon-based plasticizing resins which are by nature solid at ambient temperature.

Particularly suitable are the liquid nonaqueous and water-insoluble plasticizers selected from the group consisting of naphthenic oils (of low or high viscosity, in particular hydrogenated or nonhydrogenated), paraffinic oils, MES (Medium Extracted Solvates) oils, TDAE (Treated Distillate Aromatic Extracts) oils, mineral oils, vegetable oils, ether plasticizers, ester plasticizers, phosphate plasticizers, sulphonate plasticizers and mixtures of these compounds.

By way of nonaqueous and water-insoluble phosphate plasticizers for example, mention may be made of those which contain between 12 and 30 carbon atoms, for example trioctyl phosphate. By way of examples of nonaqueous and water-insoluble ester plasticizers, mention may in particular be made of the compounds selected from the group consisting of trimellitates, pyromellitates, phthalates, 1,2-cyclohexane dicarboxylates, adipates, azelates, sebacates and triesters of glycerol, and mixtures of these compounds. Among the above triesters, mention may in particular be made of triesters of glycerol, preferably consisting predominantly (for more than 50%, more preferentially for more than 80% by weight) of a C₁₈ unsaturated fatty acid, i.e., selected from the group consisting of oleic acid, linoleic acid and linolenic acid and mixtures of these acids. More preferentially, whether it is of synthetic or natural origin (the case, for example, of sunflower or rapeseed vegetable oils), the fatty acid used consists, for more than 50% by weight, even more preferentially for more than 80% by weight, of oleic acid. Such triesters (trioleates) having a high oleic acid content are well known, they are described, for example, in application WO 02/088238, as plasticizing agents in tyre treads.

Preferentially, the content of nonaqueous and water-insoluble liquid plasticizer is between 2 and 50 phr, more preferentially between 3 and 40 phr, even more preferentially between 5 and 35 phr.

According to another preferential embodiment of the invention, this plasticizing agent is a thermoplastic hydrocarbon-based resin of which the Tg is above 0° C., preferably above 20° C. This resin is a solid at ambient temperature (23° C.), as opposed to a liquid plasticizing compound such as an oil.

Preferably, the thermoplastic hydrocarbon-based plasticizing resin has at least any one of the following characteristics:
a Tg above 20° C., more preferentially above 30° C.;
a number-average molecular weight (Mn) of between 400 and 2000 g/mol, more preferentially between 500 and 1500 g/mol;
a polydispersity index (PDI) of less than 3, more preferentially less than 2 (reminder: PDI=Mw/Mn with Mw being the weight-average molecular weight).

More preferentially, this thermoplastic hydrocarbon-based plasticizing resin exhibits all the preferential characteristics above.

The macrostructure (Mw, Mn and PDI) of the hydrocarbon-based resin is determined by size exclusion chromatography (SEC): solvent tetrahydrofuran; temperature 35° C.; concentration 1 g/l; flow rate 1 ml/min; solution filtered through a filter with a porosity of 0.45 μm before injection; Moore calibration with polystyrene standards; set of 3 Waters columns in series (Styragel HR4E, HR1 and HR0.5); detection using a differential refractometer (Waters 2410) and associated exploitation software thereof (Waters Empower).

The thermoplastic hydrocarbon-based resins may be aliphatic, or aromatic or else of the aliphatic/aromatic type, i.e., based on aliphatic and/or aromatic monomers. They may be natural or synthetic, based or not based on petroleum (if such is the case, also known as petroleum resins).

Aromatic monomers which are suitable are, for example, styrene, α-methylstyrene, ortho-, meta- or para-methylstyrene, vinyltoluene, para-(tert-butyl)styrene, methoxystyrenes, chlorostyrenes, vinylmesitylene, divinylbenzene, vinylnaphthalene or any vinylaromatic monomer resulting from a C₉ fraction (or more generally from a C₈ to C₁₀ fraction).

Preferably, the vinylaromatic monomer is styrene or a vinylaromatic monomer resulting from a C₉ fraction (or more generally from a C₈ to C₁₀ fraction). Preferably, the vinylaromatic monomer is the minor monomer, expressed as molar fraction, in the copolymer under consideration.

According to a particularly preferential embodiment, the hydrocarbon-based plasticizing resin is selected from the group consisting of cyclopentadiene (abbreviated to CPD) or dicyclopentadiene (abbreviated to DCPD) homopolymer or copolymer resins, terpene homopolymer or copolymer resins, terpene phenol homopolymer or copolymer resins, C₅ fraction homopolymer or copolymer resins, C₉ fraction homopolymer or copolymer resins, α-methylstyrene homopolymer and copolymer resins and mixtures of these resins, which can be used alone or in combination with a liquid plasticizer, for example an MES or TDAE oil.

The term “terpene” combines here, in a known manner, the α-pinene, β-pinene and limonene monomers; use is preferentially made of a limonene monomer, which compound exists, in a known manner, in the form of three possible isomers: L-limonene (laevorotatory enantiomer), D-limonene (dextrorotatory enantiomer), or else dipentene, the racemate of the dextrorotatory and laevorotatory enantiomers. Among the hydrocarbon-based plasticizing resins above, mention will in particular be made of α-pinene, β-pinene, dipentene or polylimonene homopolymer or copolymer resins.

The preferential resins above are well known to those skilled in the art and commercially available, for example sold, as regards:
polylimonene resins: by the company DRT under the name Dercolyte L120 (Mn=625 g/mol; Mw=1010 g/mol; PDI=1.6; Tg=72° C.) or by the company

Arizona under the name Sylvagum TR7125C (Mn=630 g/mol; Mw=950 g/mol; PDI=1.5; Tg=70° C.);
C₅ fraction/vinylaromatic copolymer resins, in particular C₅ fraction/styrene or C₅ fraction/C₉ fraction copolymer resins: by Neville Chemical Company under the names Super Nevtac 78, Super Nevtac 85 or Super Nevtac 99, by Goodyear Chemicals under the name Wingtack Extra, by Kolon under the names Hikorez T1095 and Hikorez T1100, by Exxon under the names Escorez 2101 and ECR 373;
limonene/styrene copolymer resins: by DRT under the name Dercolyte TS 105, by Arizona Chemical Company under the names ZT115LT and ZT5100.

By way of examples of other preferential resins, mention may also be made of phenol-modified α-methylstyrene resins. In order to characterize these phenol-modified resins, it should be recalled that use is made, in a known manner, of a number referred to as “hydroxyl number” (measured according to standard ISO 4326 and expressed in mg KOH/g). α-Methylstyrene resins, in particular those which are phenol-modified, are well known to those skilled in the art and commercially available, for example sold by the company Arizona Chemical under the names Sylvares SA 100 (Mn=660 g/mol; PDI=1.5; Tg=53° C.); Sylvares SA 120 (Mn=1030 g/mol; PDI=1.9; Tg=64° C.); Sylvares 540 (Mn=620 g/mol; PDI=1.3; Tg=36° C.; hydroxyl number=56 mg KOH/g); Silvares 600 (Mn=850 g/mol; PDI=1.4; Tg=50° C.; hydroxyl number=31 mg KOH/g).

According to one particular embodiment of the invention, when it is included in the composition, the content of hydrocarbon-based plasticizing resin is between 5 and 50 phr, preferentially between 7 and 40 phr, even more preferentially between 10 and 35 phr. Also preferentially, the content of plasticizing resin is between 5 and 20 phr, and more preferentially between 5 and 15 phr.

Of course, the compositions in accordance with the invention can be used alone or as a blend (i.e., as a mixture) with any other rubber composition that can be used for manufacturing tyres.

It goes without saying that the invention relates to the rubber compositions previously described, both in the “raw” or noncrosslinked state (i.e., before curing) and in the “cured” or crosslinked, or else vulcanized, state (i.e., after crosslinking or vulcanization).

II—Preparation of the Rubber Compositions

The compositions are manufactured in appropriate mixers using two successive preparation phases well known to those skilled in the art: a first phase of thermomechanical working or kneading (sometimes described as “non-productive” phase) at high temperature, up to a maximum temperature of between 110° C. and 190° C., preferably between 130° C. and 180° C., followed by a second phase of mechanical working (sometimes described as “productive” phase) at a lower temperature, typically less than 110° C., for example between 60° C. and 100° C., finishing phase during which the crosslinking or vulcanization system is incorporated; such phases are described, for example, in applications EP-A-0501227, EP-A-0735088, EP-A-0810258, WO 00/05300 or WO 00/05301.

In the process in accordance with the invention, the first (non-productive) phase is preferentially carried out in several thermomechanical steps. During a first step, the elastomers are introduced into an appropriate mixer such as a usual internal mixer, at a temperature of between 20° C. and 100° C., and preferably between 25° C. and 80° C. After a few minutes, preferentially from 0.5 to 2 minutes, and an increase in temperature to 90° C. to 100° C., the starch and the aqueous or water-soluble plasticizer are added in one go or in parts (in two halves, three thirds, four quarters, or one third and then two thirds, for example) during mixing ranging from 20 seconds to a few minutes. During the subsequent steps, all the additional basic constituents, such as the fillers, the optional additional coating or processing agents and various other additives, are added according to procedures known to those skilled in the art. The total kneading time, in this non-productive phase, is preferably between 2 and 10 minutes at a temperature of less than or equal to 180° C., and preferentially less than or equal to 170° C.

The applicant has actually noted, surprisingly, that the introduction of the starch and of the aqueous or water-soluble plasticizer, in fractions or in one go, into the elastomer or the mixture of elastomers makes it possible to plasticize the starch in situ, while at the same time obtaining good dispersion, before the introduction of the other constituents of the composition.

Thus, the invention also relates to a process for obtaining a rubber composition, which comprises a first phase of thermomechanical kneading of the constituents of the composition, with the exception of the vulcanization system, characterized in that the composition also comprises a starch in a proportion of from 10 to 50 phr and an aqueous or water-soluble plasticizer in a proportion of from 3 to 30 phr and in that the starch and the aqueous or water-soluble plasticizer are incorporated during the first kneading phase, said aqueous or water-soluble plasticizer being water, or a mixture of water and glycerol in which the water is predominant by weight in the aqueous or water-soluble plasticizer.

Preferentially, the invention relates to the process as defined above, in which the proportion of starch in the composition ranges from 15 to 40 phr.

Also preferentially, the invention relates to the process as defined above, in which the proportion of aqueous or water-soluble plasticizer in the composition ranges from 7 to 28 phr.

Preferentially, the invention relates to the process as defined above, in which the first kneading phase is carried out in several steps:
a first step of kneading all the elastomers of the composition,
one or more successive steps in which the starch and the aqueous or water-soluble plasticizer are added in one portion or in parts,
final steps in which the other constituents are subsequently introduced.

Preferentially, the kneading phase is carried out at a temperature of between 25° C. and 180° C.

After cooling of the resulting mixture, the vulcanization system is then incorporated at low temperature (typically less than 100° C.), generally in an external mixer, such as an open mill; everything is then mixed (productive phase) for a few minutes, for example between 5 and 15 min.

The resulting final composition is subsequently calendered, for example in the form of a sheet or of a plaque, in particular for characterization in the laboratory, or else extruded, so as to form, for example, a rubber profiled element used for the manufacture of semi-finished products in order to obtain products such as sidewalls, a carcass ply, crown plies, a tread, a bead-wire filling, a tread sublayer or other layers of elastomers, preferentially the tread. These products can subsequently be used for manufacturing tyres, according to the techniques known to those skilled in the art.

The vulcanization (or curing) is carried out in a known manner at a temperature generally between 130° C. and 200° C., under pressure, for a sufficient period of time which can range, for example, between 5 and 90 min depending in particular on the curing temperature, on the vulcanization system adopted, on the vulcanization kinetics of the composition under consideration or else on the size of the tyre.

The examples which follow illustrate the invention without, however, limiting it.

III—Examples of Implementation of the Invention

### III-1 PREPARATION OF THE EXAMPLES

In the examples which follow, the rubber compositions were prepared as previously described.

III-2 CHARACTERIZATION OF THE EXAMPLES

In the examples, the rubber compositions are characterized after curing as indicated hereinafter.

Dynamic Properties:

The dynamic properties G* and tan(δ)max are measured on a viscosity analyser (Metravib V A4000), according to standard ASTM D 5992 - 96. The response of a sample of vulcanized composition (cylindrical test specimen with a thickness of 2 mm and a cross section of 78.5 mm²), subjected to a simple alternating sinusoidal shear stress, at a frequency of 10 Hz, is recorded under the normal temperature conditions according to standard ASTM D 1349 - 99. A peak-to-peak strain amplitude sweep is carried out from 0.1 to 50% (forward cycle) and then from 50% to 1% (return cycle). The results made use of are the complex dynamic shear modulus (G*) and the loss factor, tan(δ). The maximum value of tan(δ) observed (tan(δ)max) is shown for the return cycle. The values of G* and of tan(δ)max given hereinafter are measured at 23° C.

Dispersion:

In a known manner, the dispersion is represented by its Z value, which is measured, after crosslinking, according to the method described by S. Otto et al. in Kautschuk Gummi Kunststoffe, 58 Jahrgang, Nr 7-8/2005, in accordance with standard ISO 11345.

The calculation of Z is based on the percentage of surface not dispersed, as measured by the “disperGRADER+” apparatus provided with the procedure for said apparatus and the “disperDATA” exploitation software for said apparatus, by the company Dynisco, according to the equation:

Z=100−(% surface not dispersed)/0.35

The percentage of surface not dispersed is, for its part, measured using a camera which observes the surface of the sample under an incident light at 30°. The light points are associated with charge and agglomerates, while the dark points are associated with the rubber matrix; digital processing converts the image into a black and white image, and makes it possible to determine the percentage of surface not dispersed, as described by S. Otto in the abovementioned document.

The invention preferentially relates to a composition as defined above, which has a dispersion such that the value of Z is greater than 50 and more preferentially greater than 55.

### III-3 EXAMPLES

### III-3-1 Example I

The objective of this example is to compare the various rubber properties of a control composition which does not include starch (I-1), which is the usual tread composition, or which includes starch without plasticizer (I-2), with compositions in accordance with the invention, i.e., which comprise a starch and an aqueous or water-soluble plasticizer (I-3 and I-4). In this first example, the composition is based on a synthetic elastomer composed of a polybutadiene/copolymer of butadiene-styrene mixture.

These compositions I-1, I-2, I-3 and I-4 have the same basic formula I. This basic formula I is the following:

| | |
|---|---|
| SBR (1) | 80 |
| BR (2) | 20 |
| Carbon black N234 | 2 |
| Ozone wax | 1.5 |
| Antioxidant (3) | 1.9 |
| MES oil | 6 |
| Resin (4) | 11 |
| Stearic acid | 2 |
| ZnO | 1.5 |
| Sulphur | 1 |
| Accelerators (5) | 1.6 |
| DPG (6) | 1.5 |

(1) SBR : SBR solution (content expressed as dry SBR); 25% of styrene and 58% of 1,2-polybutadiene units and 22% of trans-1,4-polybutadiene units (Tg = −21° C.);
(2) BR: polybutadiene with 4.3% of 1,2; 2.7% of trans; 93% of cis-1,4 (Tg = −106° C.)
(3) N-(1,3-dimethylbutyl)-N-phenyl-para-phenylenediamine (6-PPD)
(4) Dercolyte L120 resin sold by the company DRT
(5) N-cyclohexyl-2-benzothiazylsulphenamide (CBS)
(6) Diphenylguanidine

The particular characteristics of compositions I-1, I-2, I-3 and I-4 are shown in Table 1 which follows. The volume fractions of reinforcing filler (carbon black and silica) are constant at 20.5% between the control I-1 and the compositions I-2, I-3 and I-4.

TABLE 1

| Composition No. | I-1 | I-2 | I-3 | I-4 |
|---|---|---|---|---|
| Starch A (7) | — | 35 | 35 | — |
| Starch B (8) | — | — | — | 35 |
| Demineralized water | — | — | 14 | 7 |
| Silica (9) | 75 | 94 | 94 | 94 |
| Coupling agent (10) | 6.1 | 7.6 | 7.6 | 7.6 |

(7) Starch A: corn starch supplied by Roquette frères
(8) Starch B: HI-CAT5163A cationic starch supplied by Roquette frères
(9) Silica: Ultrasil 7000 supplied by Degussa
(10) Coupling agent: TESPT (Si69, Degussa)

Composition I-1 is manufactured with introduction of all of the constituents onto an internal mixer. The vulcanization agents (sulphur and accelerator) are introduced onto an external mixer at low temperature (the constituent rollers of the mixer being at approximately 50° C.).

Compositions I-2, I-3 and I-4 are manufactured in accordance with the process of the invention, with introduction of the elastomers during a first step of the first mixing phase onto an internal mixer. The starch and the aqueous or water-soluble plasticizer (except for composition I-2) are introduced in three thirds during the three successive steps following this first phase onto the internal mixer. The other constituents are subsequently introduced. The vulcanization system is subsequently introduced onto an external mixer, during the second phase of the process.

Table 2 gives the properties measured after curing at 150° C. for 40 min.

TABLE 2

| Composition No. | I-1 | I-2 | I-3 | I-4 |
|---|---|---|---|---|
| G* 10% (MPa) | 3.45 | 6.05 | 4.02 | 4.74 |
| Tan (δ) max | 0.32 | 0.41 | 0.29 | 0.32 |
| Dispersion Z | 74 | 26 | 90 | 84 |

Compared with the control composition I-1, a strong improvement in stiffness is noted for compositions I-3 and I-4 comprising starch, revealed by the increase in the dynamic modulus G* at 10% strain at 23° C., whereas the hysteresis (Tan (δ) max) remains stable or even decreases slightly.

It is noted that the dispersion Z of compositions I-3 and I-4 is very good, and even better than that of the control composition.

It also appears that composition I-2 comprising starch without plasticizer, although exhibiting a very strong stiffness, is not advantageous since it exhibits a hysteresis that is too high, compared with the control composition, for use in a tyre. It is also noted that the dispersion is very poor if starch is used without plasticizer.

### III-3-2 Example II

The objective of this example is to compare the various rubber properties of a control composition which does not include starch (II-1) with compositions for a tread which are in accordance with the invention, i.e., comprising a starch with aqueous or water-soluble plasticizers which are different (II-2, II-3 and II-4). In this second example, the composition is based on synthetic elastomers composed of a BR/SBR mixture, similar to that of Example I in which the SBR(1) is replaced with an SBR functionalized at the end of the chain with a silanol coupling agent as described in the abovementioned patent applications FR 2 740 778 and U.S. Pat. No. 6,013,718: SBR composed of 25% of styrene (content expressed as dry SBR), 68% of 1,2-polybutadiene units and 22% of trans-1,4-polybutadiene units with a silanol function at the end of the chain.

Compositions II-1, II-2, II-3 and II-4 therefore have the same basic formula II, identical to the basic formula I described in Example I, with the exception of the choice of the butadiene/stryrene copolymer specified in the previous paragraph.

The specific characteristics of compositions II-1, II-2, II-3 and II-4 are given in Table 3 which follows. The volume fractions of filler are kept constant between the control (II-1) and compositions II-2, II-3 and I-4.

TABLE 3

| Composition No. | II-1 | II-2 | II-3 | II-4 |
|---|---|---|---|---|
| Starch A | — | 35 | 35 | 35 |
| Demineralized water | — | 14 | 7 | 11 |
| 90% glycerin | — | — | 7 | 3 |
| Silica (8) | 75 | 94 | 94 | 94 |
| Coupling agent (9) | 6.1 | 7.6 | 7.6 | 7.6 |

Compositions II-1, II-2, II-3 and II-4 are manufactured in accordance with the process described, respectively, for the manufacture of the compositions of Example I.

Table 4 gives the properties measured after curing at 150° C. for 40 min.

TABLE 4

| Composition No. | II-1 | II-2 | II-3 | II-4 |
|---|---|---|---|---|
| G* 10% (MPa) | 2.43 | 3.63 | 3.91 | 4.43 |
| Tan (δ)max | 0.29 | 0.30 | 0.32 | 0.33 |
| Dispersion Z | 61 | 84 | 82 | 86 |

Compared with the control composition II-1, a strong improvement in stiffness is noted for compositions II-2, II-3 and II-4 comprising starch, revealed by the increase in the dynamic modulus G* at 10% strain at 23° C., whereas the hysteresis remains stable. This observation is true with water as plasticizer or with a mixture of water and glycerin. It also appears in this example that the presence of plasticizer makes it possible to obtain a much improved dispersion of the fillers in the composition.

### III-3-3 Example III

The objective of this example is to compare the various rubber properties of a control composition which does not include starch (III-1) with compositions in accordance with the invention, i.e., comprising a starch and an aqueous or water-soluble plasticizer (III-2 and III-3). In this third example, the composition is based on a natural elastomer composed of natural rubber NR.

These compositions III-1, III-2 and III-3 have the same basic formula III.

This basic formula III is the following:

| | |
|---|---|
| NR (11) | 100 |
| Carbon black N683 | 60 |
| Antioxidant (3) | 1.3 |
| Stearic acid | 0.5 |
| ZnO | 3 |
| Sulphur | 2.4 |
| Accelerators (5) | 1.5 |

(11) NR: peptized natural rubber
(3) and (5): see Example I

The specific characteristics of compositions III-1, III-2 and III-3 are given in Table 5 which follows.

TABLE 5

| Composition No. | III-1 | III-2 | III-3 |
|---|---|---|---|
| Starch A (6) | — | 21 | — |
| Starch B (7) | — | — | 21 |
| Demineralized water | — | 8.4 | 8.4 |

(6) and (7): see Example I

Composition III-1 is manufactured with introduction of all of the constituents onto an internal mixer. The vulcanization agents (sulphur and accelerator) are introduced onto an external mixer at low temperature (the constituent rollers of the mixer being at approximately 50° C.).

Compositions III-2 and III-3 are manufactured in accordance with the process of the invention, with introduction of the elastomer during a first step of the first mixing phase onto an internal mixer. The starch and the aqueous or water-soluble plasticizer are introduced in two halves during the subsequent two successive steps of this first phase onto the internal mixer. The other constituents are subsequently introduced. The vulcanization system is subsequently introduced onto an external mixer, during the second phase of the process.

Table 6 gives the properties measured after curing at 150° C. for 15 min.

TABLE 6

| Composition No. | III-1 | III-2 | III-3 |
|---|---|---|---|
| G* | 2.18 | 3.18 | 3.17 |
| Tan (δ)max | 0.15 | 0.13 | 0.13 |

Once again, compared with the control composition III-1, a strong improvement in stiffness is noted for compositions III-2 and III-3 comprising starch, revealed by the increase in the dynamic modulus G* at 10% strain at 23° C., whereas the hysteresis decreases very slightly.

1-19. (canceled)

20. A rubber composition comprising:
a diene elastomer;
a crosslinking system;
a reinforcing filler;
a starch in a proportion of from 10 to 50 phr (parts by weight per hundred parts of elastomer); and
an aqueous or water-soluble plasticizer in a proportion of from 3 to 30 phr,
wherein the aqueous or water-soluble plasticizer is water or a mixture of water and glycerol, in which the water in the mixture is predominant by weight in the aqueous or water-soluble plasticizer.

21. The rubber composition according to claim 20, wherein the proportion of the starch ranges from 15 to 40 phr.

22. The rubber composition according to claim 20, wherein the proportion of the aqueous or water-soluble plasticizer ranges from 7 to 28 phr.

23. The rubber composition according to claim 20, wherein the starch includes a minimum of 10% of amylose.

24. The rubber composition according to claim 23, wherein the starch includes a minimum of 15% of amylose.

25. The rubber composition according to claim 24, wherein the starch includes a minimum of 20% of amylose.

26. The rubber composition according to claim 20, wherein the aqueous or water-soluble plasticizer is water.

27. The rubber composition according to claim 20, wherein reinforcing filler includes predominantly carbon black.

28. The rubber composition according to claim 20, wherein the reinforcing filler includes predominantly silica.

29. The rubber composition according to claim 20, wherein the reinforcing filler includes a blend of carbon black and silica.

30. The rubber composition according to claim 20, wherein the rubber composition is in a non-crosslinked state.

31. The rubber composition according to claim 20, wherein the rubber composition is in a crosslinked state.

32. The rubber composition according to claim 20, wherein the rubber composition is formed into a calendered or profiled product used in manufacturing a tyre.

33. The rubber composition according to claim 20, wherein the rubber composition is formed into a tyre.

34. A process for obtaining a rubber composition, the process comprising steps of:
thermomechanical kneading of constituents of a composition, the constituents excluding a vulcanization system; and
adding to the composition, during the thermomechanical kneading step, a starch in a proportion of from 10 to 50 phr and an aqueous or water-soluble plasticizer in a proportion of from 3 to 30 phr, to obtain a rubber composition,
wherein the aqueous or water-soluble plasticizer is water or a mixture of water and glycerol, in which the water in the mixture is predominant by weight in the aqueous or water-soluble plasticizer, and
wherein the thermomechanical kneading step and the adding step are part of a first kneading phase.

35. The process according to claim 34, wherein the proportion of the starch in the composition ranges from 15 to 40 phr.

36. The process according to claim 34, wherein the proportion of the aqueous or water-soluble plasticizer in the composition ranges from 7 to 28 phr.

37. The process according to claim 34, wherein the first kneading phase includes:
kneading all elastomers of the composition;
subsequently adding the starch and the aqueous or water-soluble plasticizer in one portion or in parts; and
adding other constituents of the rubber composition after the starch and the aqueous or water-soluble plasticizer are added.

38. The process according to claim 34, wherein the first kneading phase is carried out at a temperature of between 25° C. and 180° C.
